(19) United States
(12) Patent Application Publication
(10) Pub. No.: US 2025/0370409 A1
(43) Pub. Date: Dec. 4, 2025

(54) REPLICATION METHOD WITH A CONTACT BODY

(71) Applicant: Carl Zeiss Jena GmbH, Jena (DE)

(72) Inventors: Stefan SCHWEDAT, Jena (DE); Petr VOJTISEK, Jena (DE); Annett HARTMANN, Jena (DE); Mirko RIETHMUELLER, Leipzig (DE); Alexander JAKUBZICK, Muenchenbernsdorf (DE)

(21) Appl. No.: 18/878,055

(22) PCT Filed: Jun. 20, 2023
(86) PCT No.: PCT/EP2023/066662

§ 371 Date: Dec. 22, 2024

(30) Foreign Application Priority Data
Jun. 22, 2022 (DE) 10 2022 115 595.1

(51) Int. Cl. G03H 1/20

(52) U.S. Cl. CPC G03H 1/20

(57) ABSTRACT

A replication method for producing a hologram copy by simultaneous exposure of a master hologram and a copy carrier comprising a photosensitive material is provided. The contact body is brought into contact with the copy carrier during the exposure, the contact body and the copy carrier directly touching one another in a part through which exposure light is radiated during the exposure. The contact body is transparent to the exposure light, and the refractive index of the contact body is matched to the refractive index of the copy carrier. Also provided is a device for realizing the replication method.

### PRIORITY

This application claims the priority of German patent application DE 10 2022 115 595.1, filed Jun. 22, 2022, which is hereby incorporated herein by reference in its entirety.

### FIELD

In one aspect, the invention relates to a replication method for producing a hologram copy by simultaneous exposure of a master hologram and a copy carrier, which comprises a photosensitive material. During the exposure, the contact body is brought into contact with the copy carrier, wherein, during the exposure, the contact body and the copy carrier are in direct contact in a part through which an exposure light passes. The contact body is transparent to the exposure light, and the refractive index of the contact body is matched to the refractive index of the copy carrier.

In a further aspect, the invention relates to an apparatus for realizing the replication method.

### BACKGROUND

Unlike conventional imaging, for example photography, it is not only the intensity of the imaged object that is stored in holography but also phase relationships of the light coming from the object. These phase relationships contain additional spatial information, whereby it is possible, for example, to create a three-dimensional impression of the image representation and/or it is possible to realize very flexible beam shaping or beam deflection. This is done with the aid of light beam interference during the recording of the object. The object is illuminated with coherent light, and the light is reflected and scattered by the object. The wave field created, the so-called object wave, is superimposed with light that is coherent with the object wave (said light being the so-called reference wave-typically coming from the same light source, e.g. a laser), and the wave fields interfere with one another as a function of their phase relationship. The interference pattern created is recorded by means of a light-sensitive layer, for example, and hence the information contained in the phase is also stored. For reconstruction purposes, the created hologram is illuminated using a light wave that is identical or similar to the reference wave, said light wave thereupon being diffracted by the recorded interference patterns. This allows reconstruction of the original wavefront of the object wave. There are different types of holograms, e.g. transmission and reflection holograms, which create this reconstruction in transmission or reflection, respectively. For example, when an observer is situated on one side of the hologram opposite the light source in the case of a transmission hologram and views the latter, the imaged object appears three-dimensionally in front of them.

In addition to the three-dimensional representation, holograms can be used in the form of so-called holographic optical elements (HOEs), the holographic properties of which can be used for equipment optics. For example, conventional lens elements, mirrors and prisms can be replaced by HOEs. In other cases, HOEs are used as special diffraction gratings. For example, HOEs have spectral selectivity and/or selectivity in relation to the angle of incidence. At the same time, they can be completely or partly transparent to other spectral ranges and/or angles of incidence.

Holograms, especially technical holograms, can be recorded directly using various holographic methods or can be printed from computer-generated data with the aid of wavefront printers or stereo holography printers. However, as these production methods require a significant amount of time, they are not suitable for mass production of optical functions in the form of holograms. Suitable replication methods lend themselves to this end.

An important hologram replication method corresponds to the contact copying method, the technology of which is known. In this context, a photosensitive material is applied directly to what is known as the master hologram. Simultaneous exposure of the photosensitive material and of the master hologram using sufficiently coherent light results in a transfer of the optical function of the master in the form of a hologram into the photosensitive material, whereby a copy of the master hologram is created.

The optical properties to be replicated are comprised by the master hologram in suitable fashion. For example, the master hologram contains the hologram that should be copied and thus preferably represents the “original” that should be copied in the replication process.

By preference, the photosensitive material is comprised by a copy carrier. In particular, the copy carrier represents a physical manifestation which facilitates handling of the photosensitive material and e.g. represents additional stability and/or protection for this material. However, depending on the material and method used, the copy carrier can also consist of the photosensitive material if the latter is inherently stable and/or sufficiently robust, and/or the method enables suitable handling, in particular sparing handling, of the photosensitive material.

The photosensitive material is preferably applied to a carrier material, with the copy carrier comprising photosensitive material and carrier material together. However, in its simplest form, the copy carrier can comprise only the photosensitive material itself.

Designing the replication process to be suitable for mass production also requires protection for the master hologram from mechanical influences. In the simplest case, this can be achieved if the master hologram is embedded between glass plates (quartz glass, float glass, sodium silicate glass or the like). In this case, the optical properties of the holograms created by copying depend essentially on the distance (the length of the optical path) between master hologram and the photosensitive material; the smaller the distance, the more accurate the copy of the optical function of the master hologram. It may be necessary to establish so-called optical contact between the components of the exposure apparatuses, both during the production of master holograms and during the production of corresponding copies. For example, this means that the light needs to overcome a refractive index jump that is as small as possible (<0.1 as a rule) when passing from one optical medium into another optical medium. This advantageously suppresses or minimizes unwanted reflections of required light beams at specific interfaces (e.g. Fresnel reflections), and light beams at sufficiently large angles can preferably be input coupled into an optically denser medium, whereby it can subsequently be guided in this medium by total-internal reflection. This is advantageous for a number of exposure processes.

A known method is based on what is known as index matching using liquid (glycerin, cinnamon oil, ethanol, water, etc.). In this case, the essential components are arranged in a liquid bath with a refractive index-matched liquid during the exposure. This is disadvantageous in that the liquid films remain in motion (of the order of 10 nm/sec) for a very long time (minutes to hours), whereby the light passing through is modulated in terms of its phase. This means that no temporally or spatially stable wave field (interference pattern) arises in the interference field (this is where the hologram is recorded), but this wave field is mandatory for the exposure duration of the holograms. Recording holograms in accordance with this technique is time-consuming or leads to a deterioration in the hologram quality. Dealing with liquid index matching liquids is also unfavorable for hologram reproduction since the liquids have to be removed with much effort following the exposure processes, without residue or traces of cleaning remaining.

Conventional index matching, wherein solid body parts with a matched refractive index are arranged around the essential components by means of adhesive and cements is disadvantageous in that detaching securely cemented assemblies again is only possible with significant mechanical or thermal outlay or with the use of suitable solvents. Damage to the holograms or their copies is virtually impossible to avoid in this way, since these generally consist of a plastic stack of optically transparent plastics (carrier and protective film) with a photopolymer layer located in between.

The prior art has only disclosed an improvement in an optical connection between two transparent bodies, for example two light guides, by virtue of a solid body that improves (optical) contacting being introduced into the connection region between the bodies. This solid body is typically transparent and has a refractive index that is matched to the bodies to be connected.

US 2010/0124394 A1 proposes such an intermediate piece which is situated between two optical fibers and for example can find use in the case of a plug-in connection system between two optical fibers. In the process, a lubricant should additionally be used in order to prevent friction between the components involved. The object lies in improving a longer-term connection between the optical fibers.

DE 10 2007 039 630 B3 proposes the insertion of a so-called “gob”, which is a semi-finished product made of glass, between two transparent elements and subsequent shining of light through this gob. The transparent elements are deformable in order to be matched to a generally wavy and uneven surface of the gob and thus enable an automated optical inspection of the gob without disturbing effects on account of the waviness of the surface.

DE 10 2011 113 116 B3 describes a hollow body which can be filled with an immersion liquid. The immersion body is used to contact an illumination and a sample, or an imaging optical unit and a sample, to one another by way of the body. This can increase the resolution, and surface effects can be reduced. A disadvantage found here is that the pressure must be regulated by way of the pressure exerted by the immersion liquid and, moreover, a plurality of interfaces, respectively between body and contacted element and within the body between outer wall and liquid, are present in the interior and can have a negative influence on the light beams passing through.

DE 10 2011 111 545 B3 describes a mount for transparent samples, e.g. lens elements, which for example are so small that they would otherwise have to be held between tweezers. An elastomeric mount is proposed, which locks the sample in the middle from two sides, wherein a sensor can examine the sample, which is illuminated through the mount, from a third side. The mount allows the intensity of the illumination input coupled into the sample to be increased.

However, the known apparatuses and methods are restricted to very specific fields of application and are not suitable for a hologram replication method. In particular, none of the methods are suitable for the use of a replication copy carrier present in the form of a film.

The prior art has not disclosed any simple and fast method that improves the temporal and spatial coherence during the replication of a hologram, prevents unwanted reflections at an interface and develops novel exposure options.

### SUMMARY

It is an object of the invention to provide a replication method for a hologram and an exposure apparatus therefor, which do not have the disadvantages of the prior art. Provided herein is a simple and fast replication method for different copy carriers, which enables improved replication of a hologram, in particular by improving the temporal and spatial coherence during the replication and by reducing unwanted reflections at an interface and by developing novel exposure options. Also provided is a simple and cost-effective exposure apparatus for the replication method, by means of which the aforementioned replication advantages can be attained.

In an example embodiment, a replication method is provided for producing a hologram copy by simultaneous exposure of a master hologram and a copy carrier, which comprises a photosensitive material, wherein a contact body is brought into contact with the copy carrier during the exposure, wherein, during the exposure, the contact body and the copy carrier are in direct contact, preferably at least in regions, in a part through which an exposure light passes, wherein the contact body is transparent to the exposure light, and wherein the refractive index of the contact body is matched to the refractive index of the copy carrier in order to avoid exposure light reflections, preferably at contact faces between the contact body and the copy carrier.

Here, simultaneous exposure means in particular that both master hologram and copy carrier are illuminated by the same light beams and that, for example, this can allow information transfer (e.g. by way of information in the phase, the frequency, the spectrum, the polarization, propagation direction and/or the intensity of the light beam) between master hologram and copy carrier.

Exposure preferably means irradiation with electromagnetic radiation, in particular with light, so as to change the properties of the photosensitive material. An exposure preferably takes place during a limited period of time. For example, the period of time is of the order of 100 nanoseconds (ns), 1 microsecond (μs), 10 μs, 100 μs, 1 millisecond (ms), 10 ms, 100 ms, 1 second(s), 10 s, 1 minute (min) and/or 10 min.

By preference, the copy carrier comprises a holographic copy of the master hologram after the exposure procedure. However, it can be preferable for further method steps to be required for the production of the copy following the exposure.

After the replication method has finished, the copy carrier or the photosensitive material can preferably itself comprise a hologram that represents a master hologram for a subsequent replication method.

The copy carrier (e.g., see definitions above in “Background and prior art”), which comprises the photosensitive material, can comprise a glass pane and/or a film, e.g. a carrier film, i.e. preferably a film as a carrier for the photosensitive material. In this case, the fact that the copy carrier comprises the photosensitive material preferably means that the photosensitive material is present, e.g. as a layer or film, in a manner applied to the glass pane or the carrier film. In this case, the copy carrier can be planar and preferably have a first and a second side along the planar extent, wherein the first side is in particular a side facing the contact body or a side close to said contact body, and the second side is a side facing away from the contact body or a side further away (than the first side) from the contact body. The photosensitive material can be present on the first or the second side.

In principle, the copy carrier can comprise a carrier material and a photosensitive material applied to the carrier material, see above. In this case, the copy carrier can be planar and preferably have a first and a second side along the planar extent, wherein the first side is in particular a side facing the contact body or a side close to said contact body, and the second side is a side facing away from the contact body or a side further away (than the first side) from said contact body. The photosensitive material can be present on the first or the second side.

By preference, a photosensitive material is a material which can react with the exposure light during the exposure process and which can change its optical properties in a manner dependent on the properties of the incident light beams, i.e. in particular dependent on the phase, frequency, spectrum, polarization, propagation direction and/or the intensity of the light, in such a way that a hologram that is dependent on the exposure light and in particular dependent on the master hologram exposed simultaneously can arise therefrom, said hologram having optical properties that correspond to those of the master hologram at least in part, advantageously substantially.

The contact body exhibits properties of a solid body in particular in a sufficiently broad temperature range around room temperature and in particular is not liquid and/or gaseous. In this context, liquid can mean that the contact body does not flow at the time scales relevant to the exposure, i.e. in particular experiences substantially no change in shape. The time scales can be in the following range: 1 microsecond (μs) or more, 10 μs or more, 100 μs or more, 1 millisecond (ms) or more, 10 ms or more, 100 ms or more, 1 second(s) or more, 10 s or more, 1 minute (min) or more, 10 min or more, 1 hour (h) or more, 10 h or more, 1 day (d) or more, 10 d or more, 100 d or more.

The contact body can preferably be prism-shaped and/or planar.

Terms such as substantially, approximately, roughly, approx., etc. preferably describe a tolerance range of less than ±20%, preferably less than ±10%, more preferably less than ±5% and in particular less than ±1%. Specifications with substantially, approximately, roughly, approx., etc. always disclose and comprise the exact specified value as well.

The contact body and the copy carrier are in direct contact, preferably at least in regions, in a part through which an exposure light passes during the exposure. The part through which the exposure light passes preferably comprises both a portion of an interface or outer face of the contact body through which beams of the exposure light pass and a portion of an interface or outer face of the copy carrier through which the same beams of exposure light pass. Preferably, the respective outer face is the outer face facing, or closest to, the outer face of the respectively other body (i.e. the outer face of the copy carrier from the point of view of the contact body, and vice versa). In this context, the copy carrier can preferably be referred to as a body. In this case, direct contact in regions preferably means contact between contact body and copy carrier in a region without an intermediate space between the outer faces or interfaces thereof in this region. A region is preferably an area or a volume. In this case, in regions means in particular a region of the above-described part, i.e. a region comprised by this part. The exposure light from an exposure arrangement can initially pass through the copy carrier, for example following passage through a master hologram, and then exit from the copy carrier. In that case, the copy carrier is preferably in contact with the contact body at least in regions on these exit faces. In the case of an appropriately matched refractive index of the contact body (see below), this can advantageously prevent a reflection from occurring at the interface of the copy carrier and/or of the contact body, which reflection for example could irradiate the photosensitive material again and, in the process, ensure an unwanted exposure of the photosensitive material or an unwanted influencing of the desired exposure light (e.g. by interference). It can likewise be the case that at least some of the exposure light irradiates the contact body first, and then the copy carrier. In that case, the contact body is preferably in contact with the copy carrier at least in regions at the exit faces of the light at the contact body and can in this way advantageously bring about the situation in which the exposure light passes into the copy carrier substantially without changing its direction and/or without reflections at the interface of the contact body and/or of the copy carrier and hence irradiates the photosensitive material in a defined manner.

The contact body is preferably transparent to the exposure light. In this context, transparent preferably means that more than 20%, more than 30%, more than 40%, more than 50%, more than 60%, more than 70%, more than 80% or more than 90% of the exposure light is transmitted. In this case, only some of the exposure light spectrum can also be transmitted in the aforementioned manner, especially the spectral component of the exposure light that can significantly influence the photosensitive material of the copy carrier during the exposure.

The refractive index of the contact body is matched to the refractive index of the copy carrier in order to avoid exposure light reflections at contact faces between the contact body and the copy carrier.

Contact faces are preferably faces at which the contact body and the copy carrier are in direct contact. They are preferably comprised by the regions of the part through which the exposure light passes and at which contact body and copy carrier are in direct contact. Should the exposure light passing through these contact faces experience a change in refractive index, a reflection for example can occur under certain circumstances.

The refractive index preferably describes the ratio of the wavelength of the light in vacuo to the wavelength in the material, and hence as it were, by preference, the ratio of the phase speed of the light in vacuo to that in the material. The refractive index preferably is a dimensionless quantity. The refractive index can be dependent on the frequency or wavelength of the light. By preference, the assumption is made that the refractive index is substantially constant in the spectral component (see above for the definition) of the exposure light relevant here. The refractive index is important as regards the description or the behavior of light at interfaces in particular, for example for the description of reflections. Snell's law, n₁ sin α=n₂ sin β, which describes the angle of refraction β as a function of the angle of incidence α and the refractive indices involved, but also the Fresnel equations, which at interfaces at which the refractive index changes describe the reflectance and transmittance as a function of the polarization of the incident light, its angle of incidence at the interface and the refractive indices involved, are examples in this respect.

Reflections preferably occur at interfaces where there is a change in the refractive index. As described above, the dependence of reflections on the refractive indices present at the interface can be described for example by Snell's law and/or the Fresnel equations. Hence, a person skilled in the art knows what is meant by the refractive index of the contact body being matched to the refractive index of the copy carrier in order to avoid reflections of the exposure light at contact faces between the contact body and the copy carrier. Depending on the respective illumination situation, they can make a suitable choice as regards the adjustment of the refractive index of the contact body. For example, should the exposure light be radiated in such a way that the polarization of the exposure light is substantially parallel to the plane of incidence, the refractive index of the contact body can optionally be chosen in such a way that the light is incident on the contact face at Brewster's angle, and hence substantially transmitted. In this case, the copy carrier and/or the contact body preferably comprises a dielectric. A simple example would be that of adjusting the refractive index of the contact body in such a way that it substantially corresponds to that of the copy carrier.

An improved hologram copy, for which bothersome reflections at interfaces or outer faces of the copy carrier can be prevented by simple means, can be produced using this replication method. The means allow a fast and uncomplicated replication without additional cleaning steps. In particular, the method can be automated and scaled easily.

The refractive index of the contact body can differ from the refractive index of the copy carrier by less than 0.2, preferably by less than 0.05 and in particular by less than 0.01.

The contact in regions can be assisted by an adhesion between contact body and copy carrier.

Adhesion preferably describes a physical state of an interface layer, which forms between two condensed phases that come into contact, in particular solids and liquids with negligible vapor pressure. In particular, this state is characterized by mechanical cohesion, for example caused by molecular interactions in the interface layer, or else by other forces that bring about this mechanical cohesion, not all of which are completely understood and in respect of which there are somewhat different adhesion theories. By preference, adhesion can also be referred to as adhering.

Adhesion or adhering can assist the contact in regions, as described above, by virtue of said contact being mechanically stabilized by adhering. By preference, the contact face can even be enlarged as a result of the adhesion. For example, the case can arise where regions of the interfaces between the contact body and the copy carrier which have no direct contact are however close enough to one another that adhesion forces can act between the outer face of the contact body and that of the copy carrier, and said adhesion forces pull together said regions and bring these into contact. These regions of the interfaces can be regions of the interfaces adjacent to the contact area.

In particular, the contact body can have an adhesive surface in order to assist adhesion. For example, this adhesive surface can be realized by an adhesive coating for the contact body.

Advantageously, the adhesive properties are at least so substantial that stick-slip, sticking or sliding of the copy carrier on the master hologram carrier is reliably prevented. In particular, static friction of the contact body must be greater than the transverse forces that would enable slippage.

By preference, sliding or stick-slipping can be prevented by increasing the contact force of the contact body.

Advantageously, the contact body is in optical contact with the copy carrier during the exposure process. Should the adhesion be insufficient to maintain optical contact, assistance can preferably be provided by the application of pressure.

The contact body can be elastic and preferably has a Young's modulus of less than 50 MPa, preferably of less than 20 MPa, and in particular of less than 5 MPa.

A person skilled in the art is aware of suitable measuring procedures for measuring Young's modulus.

By preference, the adherence (preferably synonymous to adhesion) and/or the static friction can be described as a combined effect of: —how well the surfaces “interlock” in one another, —how strong van der Waals forces are, —the extent to which the force effect on the contact body assists the “interlock” of the contact faces. These influencing quantities of adherence/static friction preferably are greater the smaller Young's modulus of the contact body is. At the same time, the contact body should preferably behave like a solid body during contact. A preferred keyword is the so-called viscoelastic behavior. The frequency-dependent storage modulus should be in the modulus range <50 MPa, in particular for frequencies as occur in the process (preferably 0.001 to 100 Hz), but advantageously must not become so small that the body behaves like a liquid.

Hence the preferred elasticity as described above advantageously implies adhesion.

The contact body can be elastic, at least adhesive and/or pliable in regions, and contact body and copy carrier are pressed against one another during the exposure.

Pressing against one another preferably describes reciprocative pressing on one another; this can be realized in particular by relative motion and/or by the exertion of a relative force between contact body and copy carrier.

Pliability is preferably synonymous with elasticity. For example, the elasticity can be realized by an above-described Young's modulus of the contact body.

Depending on contact body adhesion, pressing on can realize what is known as laminating the contact body on the copy carrier. By preference, a lamination describes at least temporary joining of contact body and copy carrier. For example, the contact body can be laminated on the copy carrier before the exposure and can be laminated off again following the exposure.

Advantageously, improved optical contact can be realized in this way.

Pressing on and/or pressing against one another can result in the copy carrier and the master hologram, and preferably the copy carrier and at least one further optical exposure component, being pressed against one another and/or being brought into contact.

By preference, the copy carrier is situated between the contact body and the master hologram, and so pressing the contact body and the copy carrier on or against one another causes the copy carrier and the master hologram to be pressed on one another.

It may be preferable for master hologram and contact body to be configured to cause the contact body and the copy carrier situated between master hologram and contact body to press against one another and/or to cause the master hologram and the copy carrier situated between master hologram and contact body to press against one another.

In particular, this may be realized by relative motion of master hologram and contact body toward one another, wherein master hologram and copy carrier, and preferably likewise copy carrier and contact body, are preferably brought into contact and pressed against one another, and a force is exerted therebetween.

This can easily realize improved optical contact between master hologram and copy carrier and/or copy carrier and contact body.

As regards bringing the further optical exposure component and the copy carrier into contact, the further optical component can replace the master hologram, mutatis mutandis, in the description above regarding how the master hologram and the copy carrier are brought into contact, wherein the further optical exposure component can also be used in addition to the master hologram and for example is present on the same side of the copy carrier as the master hologram and for example can likewise carry out relative motion like the master hologram.

However, it can likewise be preferable for the further optical exposure component to be comprised by the contact body or be in direct optical contact therewith. Thus, copy carrier and contact body are also brought into (optical) contact by pressing the contact body and copy carrier against one another.

In this case, it can be preferable to use both a master hologram and a further optical exposure component and likewise bring the further optical exposure component into contact with the copy carrier by way of the above-described bringing into contact of the master hologram with the copy carrier and the contact body with the copy carrier.

By preference, pressing against one another likewise brings the master hologram into contact with at least one further optical exposure component. In this case, the further optical exposure component for example can be arranged on a different side of the master hologram to the contact body. However, in some of the examples described above, transfer of pressure can be implemented by pressing on the master hologram, which in turn is pressed on the further optical exposure component as a result and brought into contact with the latter.

Bringing the master hologram into contact with the further optical exposure component or pressing these parts against one another preferably likewise comprises bringing a master plate comprising the master hologram into contact with the further optical exposure component or pressing these parts against one another.

The further optical exposure component can be selected from the group comprising beam trap, input coupling prism, output coupling prism, deflection hologram, beam-shaping optical unit, beam-shaping hologram, (transparent) transport roller, (transparent) lamination roller and/or filter layer.

Within the scope of the replication, the further optical component allows the light beams to be guided accordingly in order to realize and/or improve the replication method. For example, a beam trap can prevent light beams exiting from the copy carrier from being undesirably reflected and hence causing unwanted interference with the desired exposure beams in the copy carrier. The other aforementioned components can also influence a beam in a manner that is desirable for replication. For example, the input coupling prism can initially input couple light for replication into the copy carrier; following the exit from the copy carrier, said light can then enter the master hologram operating in reflection, and as a result of which the beams reflected by the master hologram interfere in the copy carrier for replication purposes with the light beams radiated in by the input coupling prism. Due to the prism, the beams can additionally be guided to the copy carrier at a desired angle. This is advantageous, especially for production of what are known as edge-lit holograms. For example, an output coupling prism can be used to suitably guide the light beams away after these have exited from the copy carrier. The further optical exposure component can also be a roller. This is particularly advantageous for a replication method undertaken in a roll-to-roll method, and wherein the copy carrier is present in the form of what is known as an “endless” web. For example, a lamination roller can be used to temporarily laminate the copy carrier on the contact body and/or the master hologram. A further optical exposure component can likewise be a transparent roller, through the side face of which exposure light in particular is input coupled in order to be able to implement exposure of the copy carrier at a desired angle. In this case, the beam path of the exposure, mutatis mutandis, can extend in a manner analogous to the aforementioned input coupling prism.

Within a region to be exposed, the contact body and a side of the copy carrier facing away from the master hologram are in direct contact during the exposure.

As a result, optical contact can advantageously be established where it is required, specifically in the region of the copy carrier to be exposed.

The refractive index of the contact body can be matched to the refractive index of the master hologram and/or the refractive index of further optical exposure components.

In particular, the refractive index is adjusted in such a way that reflections at the interfaces can be prevented or reduced. This allows unwanted reflections back into the copy carrier to be suppressed during the exposure process.

The matched refractive indices can differ by less than 0.2, preferably differ by less than 0.05, and in particular differ by less than 0.01.

This allows for improved matching.

The refractive indices of the contact body, of the copy carrier, of the master hologram and/or of the further exposure component can be selected such that, for a light beam of exposure light when passing through any three of these components, the refractive index of the component passed through second lies between the refractive indices of the other components.

For example, the refractive index of the copy carrier located between master hologram and contact body can be between the refractive indices of contact body and master hologram. The same can apply, mutatis mutandis, to a copy carrier located between master hologram and further exposure components or for a copy carrier located between contact body and further exposure component.

This can particularly effectively reduce an unwanted reflection at one of the interfaces between the components.

The frequency-dependent Young's modulus (storage modulus) of the contact body can be at least 10 times greater, preferably at least 100 times greater and in particular at least 1000 times greater than the associated loss modulus (internal friction losses) of the contact body.

A person skilled in the art knows how to use tabulated values and/or measurements to determine Young's modulus and the loss modulus of the contact body.

As a result, optical contact can be realized in particularly stable fashion.

The copy carrier can include a planar element, in particular a glass pane.

This is of particular interest to the production of a (second) master hologram from the master hologram (in what is known as a mastering process) since it is particularly desirable for the (second) master hologram to be mechanically stable in order to be able to be used in a multiplicity of replication processes and thus capable of storage and transport.

The copy carrier can include at least one film.

The fact that the copy carrier comprises a film, in particular a so-called “endless film” or “endless roll”, is of particular interest to a replication method realized as a roll-to-roll method.

The web material (the copy carrier) is tensioned in particular by the web alignment by way of so-called rollers or rolls.

For example, this can be a PC film, for example with a layer thickness of 125 μm. A plurality of so-called film stacks preferably come to question for the copy carrier. For example, such a stack may comprise polycarbonate (PC), triacetate (TAC), polyamide (PA) and/or polyethylene terephthalate (PET). The film thicknesses of the films comprised can range between 50 μm and 300 μm and be 60 μm, 70 μm, 125 μm and/or 250 μm in particular.

The copy carrier can include a photosensitive material.

For example, the latter can be present between two films or on one film.

The photosensitive material can include a photopolymer.

The copy carrier can be exposed at least in part through the contact body.

Should optical contact advantageously be established between copy carrier and contact body during the exposure, an unwanted reflection at the interface of the copy carrier in contact with the contact body can be prevented in this way.

The body can include a molded body with a convexly shaped contact face.

The contact face is preferably the outer face of the contact body provided for contact with the copy carrier at least in regions. By preference, this definition applies not only to the embodiment specified here but also to the contact body in general.

A convex shape can allow particularly advantageous contacting of the copy carrier. Especially in combination with the embodiment of the contact body that is elastic in the aforementioned fashion, this allows first contact between copy carrier and contact body to be established at a point or a line of the convex contact face. Under continual increase of the pressure between contact body and copy carrier (preferably caused by pressing contact body and master hologram or further optical exposure components with a copy carrier located therebetween against one another), it is thus possible to advantageously continually increase the contact area, and unwanted air inclusions between contact body and copy carrier can advantageously be avoided.

The convex contact face can preferably have a radius of curvature of between 50 mm and 50 000 mm, preferably between 50 mm and 5000 mm, particularly preferably between 50 mm and 4000 mm.?

The approximate dimensions of the contact body (height×width×depth) can preferably be between 0.01×200×200 mm3 and 500×1000×1000 mm3, e.g. in the case of planar step and repeat copy methods.0

The contact body can include a transport and/or lamination roller for the copy carrier.

By preference, this can relate to idler or driven lamination rollers for its transport and/or the lamination of the copy carrier on the master hologram carrier. These can be simultaneously passed by radiation during the exposure and thus additionally fulfill the function described herein.

The contact body can include a film that is adhesive at least on one side.

The latter can preferably be brought into contact with the copy carrier around a face comprised by the exposure beam and for example be arranged between copy carrier and master hologram, although it can also (e.g. additionally) be arranged on the side of the copy carrier facing away from the master hologram in order to realize optical contacting with a further contact body and/or a further exposure component there.

By preference, the film is adhesive on both sides to this end, in order to enable optical contacting as a result of the adhesion forces between the aforementioned components.

Use can be made of two contact bodies, with the one contact body preferably being the film that is adhesive at least on one side. In that case, this film is preferably the second contact body, and the other contact body is preferably the first contact body.

In an embodiment, the copy carrier itself can comprise the contact body in the form of a film that is adhesive at least on one side, specifically if a preferably pre-crosslinked photopolymer that acts as an adhesive film itself is situated on at least one side of the copy carrier.

In another embodiment, the film that is adhesive at least on one side is laminated on the copy carrier in regions and temporarily (for the exposure).

In a further preferred embodiment, the film has a thickness of between 10 μm and 90 μm, preferably 50 μm.

In a further preferred embodiment, the contact body has an unbound monomer and/or auxiliary additive content of <0.1 wt. %.

These are preferably constituent parts in the material which are able to migrate in the material, accumulate at the material surfaces and contaminate adjacent contact faces under the action of force, temperature or negative pressure. For example, these may be additives that are used in the production of the contact body and cannot be 100% depleted even therein.

In a further preferred embodiment, the contact body has a mechanical strength of between 0.25 and 20 MPa, preferably between 0.5 MPa and 5 MPa.

For example, this mechanical strength can be ascertained by tensile tests, as known to a person skilled in the art.

In a further preferred embodiment, the contact body has a negligible tendency to exhibit stress birefringence, even in the case of relatively large layer thicknesses.

By preference, stress birefringence depends on specific process conditions such as pressures and/or shearing forces. Thus, a person skilled in the art knows how to be able to realize a small stress birefringence.

The stress birefringence is preferably so small that a maximum Δn between different directions is less than 10%, preferably less than 5% and in particular less than 1% in relation to the larger one of the ascertained refractive indices.

In particular, the stress-induced birefringence should be smaller than that of the copy carrier.

In a further preferred embodiment, the contact body comprises a material selected from the group of RTV silicones, epoxides, acrylates and/or polyurethanes.

For example, RTV silicones can be Elastosil RT601 or Elastosil RT 604 by Wacker.

In particular, these can be room temperature-crosslinking two-component silicone resins.

In a further preferred embodiment, the contact body and the copy carrier are brought into contact for the exposure (preferably by a relative motion) and are removed from one another again following the exposure process. This can be realized within the scope of a replication system, for example with the aid of appropriate actuators and/or an electronic control unit (e.g. processor, microprocessor, integrated circuit). This allows an exposure phase and a transport phase of the copy carrier, for example, to be realized during the replication.

In a further preferred embodiment, the contact between the contact body and the copy carrier is interlocking and/or implemented without an intermediate space between the contact body and the copy carrier.

This can improve optical contact.

In order to avoid air inclusions at the contact face between the contact body and the copy carrier, the contact body and the copy carrier are brought into contact (relative motion) via a first, initial contact face, with the contact face subsequently being enlarged continually until a desired contact face is obtained.

In particular, this can avoid disturbing air inclusions, which can cause reflections.

In a further preferred embodiment, pressing on is implemented with a pressure of 1-5×10⁶ Pa, preferably 1-1×10⁶ Pa and in particular 1-1×10⁴ Pa.

These pressures were found to be particularly advantageous for the establishment of temporary optical contact, especially in conjunction with the preferred elasticity of the contact body.

In a further preferred embodiment, the exposure light is comprised in a wavelength range of 400 to 900 nm.

In a further aspect, provided herein is an exposure apparatus for a replication method for producing a hologram copy of a master hologram, preferably according to the description contained herein, comprising:
a first arrangement for providing a master hologram,
a second arrangement for providing a copy carrier, which comprises a photosensitive material,
an exposure arrangement comprising a light source for an exposure light, and
a contact body that is transparent to the exposure light,
wherein the first arrangement, second arrangement, exposure arrangement and preferably the contact body are configured for simultaneous exposure of the master hologram and of the copy carrier,
wherein the contact body and the copy carrier are brought into contact and, during the exposure, are in direct contact, preferably at least in regions, in a part through which the exposure light passes,
wherein the refractive index of the contact body is matched to the copy carrier in order to avoid exposure light reflections, preferably at contact faces between the contact body and the copy carrier.

It is clear to a person skilled in the art that advantages, definitions and embodiments of the method provided herein likewise apply to the claimed apparatus also provided herein.

The first arrangement for providing a master hologram preferably comprises a master hologram or provides the latter as desired. For example, this can be a holding element for the master hologram which secures said master hologram in mechanically stable fashion and preferably in a manner stationary in space. However, it can also be preferable for the holding element to be held the master hologram translationally in space in order for example to bring the master hologram, copy carrier and/or contact body into contact, or press these on one another, during the exposure process. For example, this can be realized in hydraulic, pneumatic, mechanical and/or electromagnetic fashion.

By preference, the first arrangement for providing a master hologram can likewise comprise a roller that in turn comprises the master hologram, for example as shown in FIG. 4. This can be advantageous for exposure in a roll-to-roll method in particular. In this case, the roller can be transparent. The master hologram can be situated on the lateral face of the roller or else at a slight distance from the lateral face in the interior of the roller. In this case, the roller can be mounted in permanently stationary fashion. In other examples, the roller can be mounted translationally in order for example to bring the master hologram, copy carrier and/or contact body into contact, or press these on one another, during the exposure process. For example, this can be realized in hydraulic, pneumatic, mechanical and/or electromagnetic fashion.

A second arrangement for providing a copy carrier preferably comprises a copy carrier or provides the latter as desired. For example, this can be a holding element for the copy carrier which secures said copy carrier in mechanically stable fashion and preferably in a manner stationary in space. However, it can also be preferable for the holding element to be held for the copy carrier translationally in space in order for example to bring the master hologram, copy carrier and/or contact body into contact, or press these on one another, during the exposure process. For example, this can be realized in hydraulic, pneumatic, mechanical and/or electromagnetic fashion.

By preference, the second arrangement for providing a copy carrier can likewise comprise a so-called “endless” film for a roll-to-roll method (e.g., see FIG. 4); moreover, one or more transport rollers can be comprised. In this case, the copy carrier can be mounted in permanently stationary fashion. In other examples, the copy carrier can be mounted translationally in order for example to bring the master hologram, copy carrier and/or contact body into contact, or press these on one another, during the exposure process. For example, this can be realized in hydraulic, pneumatic, mechanical and/or electromagnetic fashion, for example by way of one or more translationally mounted transport rollers.

In this case, the contact body can be mounted or secured in stationary fashion, for example by a holding element for the copy carrier. However, it can likewise be translationally mounted, for example by a holding element for the copy carrier, in order for example to bring the contact body, copy carrier and/or master hologram into contact, or press these on one another. For example, this can be realized in hydraulic, pneumatic, mechanical and/or electromagnetic fashion.

In a preferred embodiment, the contact body and copy carrier are configured for adhesive contact between one another or among one another.

In a further preferred embodiment, the contact body is elastic and preferably has a Young's modulus of less than 50 MPa, preferably less than 20 MPa and in particular less than 5 MPa.

In a further preferred embodiment, the exposure apparatus comprises further optical exposure components, wherein the further optical exposure components are selected from the group comprising beam trap, input coupling prism, output coupling prism, deflection hologram, beam-shaping optical unit, beam-shaping hologram, transport roller, lamination roller and/or filter layer.

In a further preferred embodiment, the second arrangement and contact body are configured to press on one another during the exposure, wherein pressing on is implemented preferably with a pressure of 1-5×10⁶ Pa, preferably 1-1×10⁶ Pa and in particular 1-1×10⁴ Pa.

For example, pressing-on can be realized in hydraulic, pneumatic, mechanical and/or electromagnetic fashion.

In a further preferred embodiment, pressing on results in the copy carrier and the master hologram, and preferably the copy carrier and further optical exposure components, being brought into contact.

In a further preferred embodiment, the frequency-dependent Young's modulus (storage modulus) of the contact body is at least 10 times greater, preferably at least 100 times greater and in particular at least 1000 times greater than the associated loss modulus (internal friction losses) of the contact body.

In a further preferred embodiment, the copy carrier comprises a planar element, in particular a glass pane.

In a further preferred embodiment, the copy carrier comprises at least one film.

In a further preferred embodiment, the photosensitive material comprises a photopolymer.

In a further preferred embodiment, the contact body comprises a molded body with a convexly shaped contact face.

In a further preferred embodiment, the first arrangement, second arrangement, exposure arrangement and contact body are configured for an at least partial exposure of the copy carrier through the contact body.

In a further preferred embodiment, the contact body comprises a transport and/or lamination roller for the copy carrier.

In this case, the roller can comprise silicone and/or glass in particular. Preferably, this can relate to a roller made of glass which, especially in the region of the lateral face, is provided with a silicone layer that can advantageously afford desired mechanical strengths and Young's moduli as described herein, as well as improved homogeneity.

In particular, the roller can be transparent. Exposure light in particular is input coupled through the side face of said roller in order to be able to expose the copy carrier at a desired angle. In this case, mutatis mutandis, the exposure beam path can extend in a manner analogous to that of the aforementioned input coupling prism.

In a further preferred embodiment, the contact body comprises a film that is adhesive at least on one side.

In a further preferred embodiment, the film has a thickness of between 10 μm and 90 μm, preferably 50 μm.

In a further preferred embodiment, the contact body has an unbound monomer and/or auxiliary additive content of <0.1 wt. %.

In a further preferred embodiment, the contact body has a mechanical strength of between 0.25 and 20 MPa, preferably between 0.5 MPa and 5 MPa.

In a further preferred embodiment, the contact body has a negligible tendency to exhibit stress birefringence, even in the case of relatively large layer thicknesses.

In a further preferred embodiment, the contact body comprises a material selected from the group of RTV silicones, epoxides, acrylates and/or polyurethanes.

In a further preferred embodiment, the contact body and the second arrangement are configured for bringing together of the contact body and the copy carrier for the exposure and a removal of said contact body and copy carrier from one another after the exposure process.

In a further preferred embodiment, the contact body and the second arrangement are configured for interlocking contact between the contact body and the copy carrier and/or for contact without an intermediate space between the contact body and the copy carrier.

For example, this can be realized by virtue of the contact body and/or copy carrier being translationally mounted, as has already been described above. To this end, an above-described control unit can be used for control purposes.

In a further preferred embodiment, the contact body and the second arrangement are configured to bring the contact body and the copy carrier into contact by way of a first, initial contact face and to subsequently continually enlarge the contact face until a desired contact face is obtained.

In a further preferred embodiment, the exposure apparatus is configured to create the exposure light in a wavelength range from 400 to 900 nm.

### BRIEF DESCRIPTION OF THE DRAWINGS

The intention is to explain the invention below with reference to further drawings and examples. The examples and drawings serve to illustrate a preferred embodiment of the invention without restricting the latter.

FIG. 1 shows two steps of a replication method according to one embodiment using a contact body.

FIG. 2 shows two steps of a replication method according to a further embodiment using a contact body.

FIG. 3 shows a simplified illustration of a recording of images by replicated holograms, wherein one was produced by a state-of-the-art method and one was produced by a method according to the invention.

FIG. 4 shows a replication method according to an embodiment in the roll-to-roll method.

FIG. 5 shows a replication method according to an embodiment with a contact body in the form of a body with a convex contact face.

FIG. 6 shows a replication method with a contact body in the form of a film.

### DETAILED DESCRIPTION

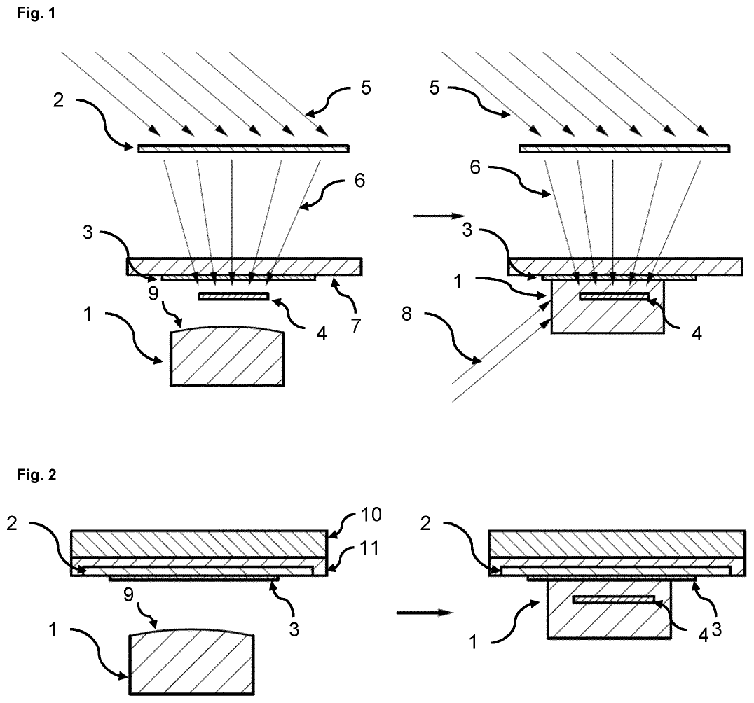

FIG. 1 shows two steps of a replication method according to one embodiment using a contact body. An exposure radiation 5 is directed at the master hologram 2, which is transmissive in this case, for the purpose of reconstructing the latter. The information stored in the master hologram 2 leads to the creation of a light field 6 that comprises this information and passes through the copy carrier 3. The latter can comprise the glass plate or a carrier material 7, wherein reference sign 3 then preferably denotes the photosensitive material and reference sign 10 denotes the glass plate/the carrier material, wherein these two parts together advantageously form the copy carrier. In an alternative, the glass plate 7 can also additionally be used to radiate the light into the copy carrier 3 and/or used to mount the copy carrier 3 and/or used as a beam trap. In the case shown, the information stored in the master hologram is such that a real image 4 is created. The exposure radiation 5 is directed at the master hologram 2 at an angle, wherein the master hologram 2 creates the deflected light field 6. What can be achieved as a result of the oblique light incidence of the exposure radiation 5 and the distance between the master hologram 2 and copy carrier 3 is that the zeroth (non-diffracted) order of the master hologram 2 does not reach the copy carrier and does not interfere with the light field 6. Optionally, the glass plate 7 can act as a beam trap for the non-diffracted light, which is guided away therein by way of total-internal reflection.

The contact body 1 is not in contact with the copy carrier 3 on the left-hand side. No reference beam is guided into the copy carrier 3, and so only the light field 6 is incident there. Accordingly, there is no interference between this light field 6 and a further field, and so it may not be possible to transfer all the information of the light field 6 into the copy carrier 3. Reflections of the light field 6, which could create unwanted light beams in the copy carrier 3, may occur at the lower interface of the copy carrier 3 as a result of a difference in the refractive index between the copy carrier 3 and the surroundings. An elastic contact body 1 with a convex contact face 9, shown below the described arrangement in the left-hand image, is not in contact with the copy carrier 3. The contact body 1 has a refractive index matched to the copy carrier 3, for example a very similar refractive index that differs by less than 0.2 from that of the copy carrier 3.

The reference beam 8, which is directed at the copy carrier 3 in the right-hand image, is required for an exposure of the copy carrier 3. In order to allow the reference beam 8 to radiate into the copy carrier 3 without reflections and in order to prevent the above-described reflections of the light field 6 at the lower interface of the copy carrier 3, the copy carrier 3 is brought into contact with the contact body 1 in the image shown on the right. As a result of moving the contact body 1 to the copy carrier 3 and exerting a force between these two, adhesion between contact body 1 and copy carrier 3 arises on account of the elasticity of the contact body 1. Moreover, the convex contact face 9 of the elastic contact body 1 is flattened, and an air gap between contact body 1 and copy carrier 3 is closed without air inclusions.

The contact body 1 can be shaped such that the reference beams 8 (which are part of the exposure light) can be guided through the contact body 1 at a desired angle through the copy carrier 3 over preferably the full extent thereof, and so contact body 1 and the copy carrier 3 are in contact during the exposure in a part through which an exposure light passes.

Should the glass plate 7 act as a beam trap, the glass plate 7 can also be considered to be a further optical exposure component. By pressing contact body 1 and copy carrier 3 against one another, the copy carrier 3 located between contact body and glass plate 7 is advantageously likewise pressed against the glass plate 7, and hence (optical) contact between these is realized or improved.

FIG. 2 shows two steps of a replication method according to a further embodiment using a contact body 1. Reference signs identical to those in FIG. 1 preferably denote the same components as in FIG. 1. In the example shown, the exposure of the copy carrier 3 is preferably implemented from below, through the contact body 1. The master hologram 2 is arranged in a master plate 11. The master hologram 2 is preferably a reflective hologram. Due to exposure from below through the copy carrier 3, the master hologram 2 reflects light beams having the information contained in the master hologram 2. These light beams interfere with the light beams that come from below in the copy carrier 3 and thus create the replicated hologram therein. The arrangement of the contact body 1 and its approach to the copy carrier 3 (laminated on the master plate 11 in this case) in the right-hand image is analogous to FIG. 1. However, a further optical exposure component, specifically a beam trap 10, is arranged above the master plate 11 in this case. Said further optical exposure component is intended to capture light beams not reflected by the master hologram 2 and prevent an unwanted back-reflection above the master plate 11. Therefore, optical contact between master plate 11 and beam trap 10 is preferably also realized at this point by way of a refractive index difference between these two that is adapted to the best possible extent.

In the example shown, pressing the contact body 1 on the copy carrier 3 preferably leads to improved contact between the copy carrier 3 and the master hologram 2 and between the copy carrier 3 and the beam trap 11 (via the master hologram 2) or the master hologram 2 or the master plate 11 with the beam trap 10, and possible air inclusions between the components can be reduced in this way.

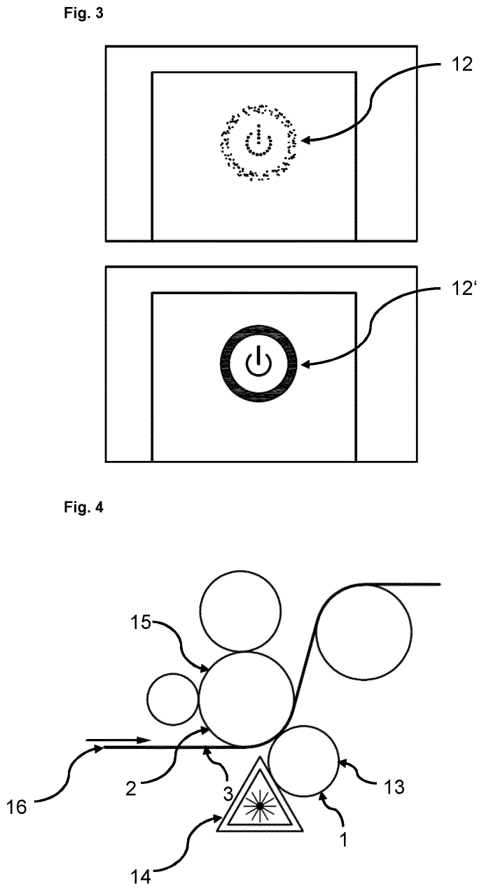

FIG. 3 shows a schematic illustration of recordings of two images created by replicated holograms, wherein the upper image was produced by a state-of-the-art method and the lower image was produced by a method according to the invention.

The created images 12, 12′ each represent the known symbol of an on/off switch.

The upper hologram was replicated by way of a state-of-the-art method, in which a copy carrier was (optically) contacted with a glass block and an interposed liquid (glycerin), and wherein the exposure was performed through the glass block. It is evident that the image 12 is not imaged throughout and hence appears less sharp and less bright.

The lower image 12′, by contrast, was created by a method according to the invention in which a silicone block was used as contact body, the latter being brought into contact with the copy carrier and the exposure being performed therethrough. As a result of improved optical contacting, the lower image 12′ is more homogeneous, brighter and sharper, which was depicted schematically in easily comprehensible fashion by way of the continuous, more homogenous and stronger picture elements.

FIG. 4 shows a replication method according to an embodiment in the roll-to-roll method. The contact body 1 is the roller 13 in the example shown. For example, this can be a transport and/or lamination roller. The roller 15 comprises the master hologram 2. Exposure is implemented via the light source 14 (e.g. laser). The copy carrier 3 is comprised in the “endless film” 16. The direction of movement is from left to right (depicted by the arrow). Otherwise, the master hologram 2 in the example shown is a reflection hologram, and the exposure is preferably implemented like in the example shown in FIG. 2.

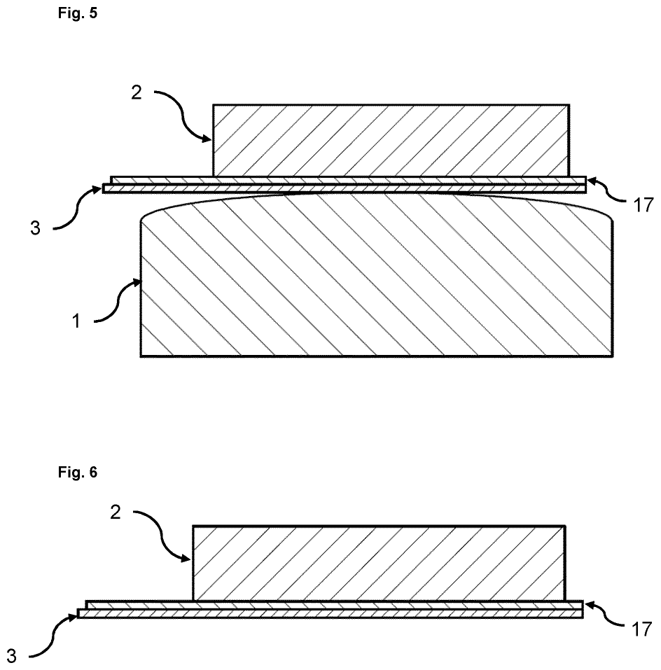

FIG. 5 shows a replication method according to an embodiment with a contact body 1 in the form of a body with a convex contact face 9. This corresponds, mutatis mutandis, to the example shown in FIG. 2, wherein the master hologram 2 can also be a transmission hologram here and the exposure can be implemented accordingly from above in accordance with the arrangement of the components shown in the figure. In this exemplary embodiment, the non-diffracted exposure light (zeroth order of the master hologram 2) can interfere with the exposure light, created by the master hologram 2, in the copy carrier 3 and can create the hologram to be replicated there. The refractive index-matched contact body 1 in contact with the copy carrier 3 from below can ensure firstly that no unwanted reflections occur on the lower side of the copy carrier 3 by way of the optical contact. Secondly, pressing the contact body 1 on the copy carrier 3 can simultaneously press the copy carrier 3 on the master hologram 2, whereby the (optical) contact between these is likewise advantageously established or improved. A further “layer” 17, which is optional, is plotted here. This represents a second, planar contact body, for example in the form of a film, which is present between master hologram and copy carrier and which establishes or improves the optical contact there. Pressing on the contact body 1 can likewise improve the contact here. This second contact body 17 is preferably adhesive at least on one side, preferably by way of its elastic properties and/or by way of an adhesive coating.

FIG. 6 shows a replication method only with a planar contact body in the form of a film 17, which improves the optical contact between master hologram 2 and copy carrier 3.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products. Moreover, features or aspects of various example embodiments may be mixed and matched (even if such combination is not explicitly described herein) without departing from the scope of the invention.

### LIST OF REFERENCE SIGNS

1 Contact body
2 Master hologram
3 Copy carrier
4 Real image
5 Exposure radiation
6 Light field created by an illuminated master hologram
7 Glass pane
8 Reference beam
9 Convex contact face
10 Beam trap
11 Master plate
12, 12′ Images created by replicated holograms
13 Roller comprising contact body
14 Exposure source
15 Roller comprising master hologram
16 Endless film
17 Planar or film-shaped contact body

1-28. (canceled)

29. A replication method for producing a hologram copy by simultaneous exposure of a master hologram and a copy carrier, which comprises a photosensitive material, the method comprising:
bringing a contact body into contact with the copy carrier during the exposure, wherein, during the exposure, the contact body and the copy carrier are in direct contact in a part through which an exposure light passes, and wherein the contact body is transparent to the exposure light, and
matching the refractive index of the contact body to the refractive index of the copy carrier in order to avoid exposure light reflections.

30. The replication method of claim 29, wherein the contact in regions is assisted by an adhesion between the contact body and the copy carrier.

31. The replication method of claim 29, wherein the contact body is elastic and has a Young's modulus of less than 50 MPa.

32. The replication method of claim 29,
wherein the contact body is elastic and/or pliable,
the method further comprising pressing the contact body and the copy carrier against one another during the exposure.

33. The replication method of claim 32, wherein the pressing step is implemented with a pressure of 1-5×106 Pa.

34. The replication method of claim 32,
wherein the pressing step results in the copy carrier and the master hologram, and the copy carrier and at least one further optical exposure component, being pressed against one another and/or being brought into contact, and
wherein the further optical exposure component is selected from the group consisting of: a beam trap, an input coupling prism, an output coupling prism, a deflection hologram, a beam-shaping optical unit, a beam-shaping hologram, a transport roller, a lamination roller and/or filter layer.

35. The replication method of claim 29, wherein the contact body and a predominant part of the side of the copy carrier facing away from the master hologram are in direct contact during the exposure.

36. The replication method of claim 29,
further comprising matching the refractive index of the contact body to the refractive index of the master hologram and/or the refractive index of further optical exposure components,
wherein the matched refractive indices differ by less than 0.2.

37. The replication method of claim 29, wherein the copy carrier is exposed at least in part through the contact body.

38. The replication method of claim 29, wherein the contact body comprises a molded body with a convexly shaped contact face.

39. The replication method of claim 29, wherein the contact body comprises a transport and/or lamination roller for the copy carrier.

40. The replication method of claim 29, wherein the contact body comprises a film that is adhesive at least on one side.

41. The replication method of claim 29, further comprising bringing the contact body and the copy carrier into contact for the exposure, and removing the contact body and the copy carrier contacting one another following the exposure step.

42. The replication method of claim 29, wherein the contact between the contact body and the copy carrier is interlocking and/or implemented without an intermediate space between the contact body and the copy carrier.

43. The replication method of claim 29, wherein the copy carrier comprises a carrier material and a photosensitive material applied to the carrier material.

44. An exposure apparatus for a replication method for producing a hologram copy of a master hologram, the exposure apparatus comprising:
a first arrangement for providing a master hologram;
a second arrangement for providing a copy carrier, which comprises a photosensitive material;
an exposure arrangement comprising a light source for an exposure light; and
a contact body that is transparent to the exposure light,
wherein the first arrangement, second arrangement, exposure arrangement and the contact body are configured for simultaneous exposure of the master hologram and of the copy carrier,
wherein the contact body and the copy carrier are brought into contact and, during the exposure, are in direct contact in a part through which the exposure light passes, and
wherein the refractive index of the contact body is matched to the copy carrier in order to avoid exposure light reflections.

45. The exposure apparatus of claim 44, wherein contact body and copy carrier are configured for adhesive contact between one another.

46. The exposure apparatus of claim 44, wherein the contact body is elastic and has a Young's modulus of less than 50 MPa.

47. The exposure apparatus of claim 44,
wherein the exposure apparatus comprises further optical exposure components,
wherein the further optical exposure components are selected from the group consisting of: a beam trap, an input coupling prism, an output coupling prism, a deflection hologram, a beam-shaping optical unit, a beam-shaping hologram, a transport roller, a lamination roller and/or a filter layer.

48. The exposure apparatus of claim 44,
wherein second arrangement and contact body are configured to press on one another during the exposure, and
wherein pressing on is implemented with a pressure of 1-5×106 Pa.

49. The exposure apparatus of claim 48, wherein the step of pressing on results in the copy carrier and the master hologram, or the copy carrier and further optical exposure components, being brought into contact.

50. The exposure apparatus of claim 44, wherein the contact body comprises a molded body with a convexly shaped contact face.

51. The exposure apparatus of claim 44, wherein a first arrangement, a second arrangement, an exposure arrangement and a contact body are configured for an at least partial exposure of the copy carrier through the contact body.

52. The exposure apparatus of claim 44, wherein the contact body comprises a transport and/or lamination roller for the copy carrier.

53. The exposure apparatus of claim 44, wherein the contact body comprises a film that is adhesive at least on one side.

54. The exposure apparatus of claim 44, wherein the contact body and the second arrangement are configured for bringing the contact body and the copy carrier into contact for the exposure and a removal of said contact body and copy carrier from one another after the exposure process.

55. The exposure apparatus of claim 44, wherein the contact body and the second arrangement are configured for interlocking contact between the contact body and the copy carrier and/or for contact without an intermediate space between the contact body and the copy carrier.

56. The exposure apparatus of claim 44, wherein the copy carrier comprises a carrier material and a photosensitive material applied to the carrier material.
